(19) United States
(12) Patent Application Publication
(10) Pub. No.: US 2014/0272370 A1
(43) Pub. Date: Sep. 18, 2014

(54) Renewable Thermoplastic Starch-Polyolefin Compositions Comprising Compatibilizer and Flexible Thin Films Made Therefrom

(71) Applicant: The Procter & Gamble Company, Cincinnati, OH (US)

(72) Inventors: Norman Scott BROYLES, Hamilton, OH (US); William Maxwell ALLEN, JR., Liberty Twp, OH (US); Isao NODA, Fairfield, OH (US)

(73) Assignee: The Procter & Gamble Company, Cincinnati, OH (US)

(21) Appl. No.: 14/208,634

(22) Filed: Mar. 13, 2014

Related U.S. Application Data
(60) Provisional application No. 61/798,397, filed on Mar. 15, 2013.

(51) Int. Cl. C08L 23/26

(52) U.S. Cl. CPC C08L 23/26
USPC 428/220; 524/52

(57) ABSTRACT

A compatibilized thermoplastic polymer composition having from 5% to 95% bio-based content and comprising thermoplastic starch; polyolefin; and an effective amount of compatibilizer. The compatibilizer can include polar homopolymers and copolymers with inherent polyolefin compatibility; non-polymeric materials with both polar and non-polar functionality; low molecular weight materials with both polar and non-polar functionality; and bulk phase/in-situ compatibilizers. Alternatively, polyolefin can be modified to function as the compatibilizer. The composition is suitable for making flexible thin films and packaging components, such as those used for packaging consumer products.

### FIELD OF THE INVENTION

The present invention relates to renewable thermoplastic starch—polyolefin compositions comprising compatibilizer. The compositions have from 5%-95% bio-based content. The present invention also relates to flexible thin films made from such compositions.

### BACKGROUND OF THE INVENTION

Most thermoplastic polymers are derived from monomers that are obtained from non-renewable, fossil-based resources such as petroleum, natural gas, and coal. In recent years, as manufacturers and consumers have gained a greater awareness of environmental and sustainability concerns, the demand for polymers made from renewable, non-fossil-based materials has grown significantly. One such renewable polymer that is commonly available is thermoplastic starch (“TPS”).

Starch is a natural carbohydrate storage material accumulated in plants in the form of granules and is a biodegradable, annually renewable resource of low cost. It is composed of linear polysaccharide molecules (amylose) and branched molecules (amylopectin). Native starch granules swell when they absorb water through hydrogen bonding with their free hydroxyl groups. When these swollen starch granules are heated, gelatinization occurs. The addition of a plasticizer such as glycerol combined with heating and high shear can further improve the ductility of gelatinized starch and the obtained plasticized starch is known as TPS.

TPS is very affordable, making it especially desirable for use in consumer product packaging films that are meant to be discarded by the consumer. Unfortunately, however, TPS is not suitable for solo use in most stand-alone applications. TPS has low melt strength and low extensibility, making it commercially unsuitable for processing into thin films. Furthermore, TPS is a very hydrophilic, moisture-sensitive material, making it inherently unsuitable for most applications. Because of its many limitations, TPS is usually used only as a minor component in fossil-based polymer blends.

Polyolefins (“PO”), such as polyethylene and polypropylene, are commonly used to produce thin films for consumer product packaging because of their excellent processability. As a result, common film-manufacturing equipment is optimally designed for making polyolefin-based films. Replacing or modifying this manufacturing equipment to run other types of polymers would require high development costs and excessive capital expenditures, making this option impractical for most manufacturers.

Accordingly, relatively inexpensive polymers that are not only suitable for making thin films using standard polyolefin film-manufacturing equipment, but also contain significant bio-based content, are highly desirable. A polymer having the advantages of both TPS and PO would be very useful for making such thin films. Rather than synthesize a totally new polymeric material having the desired attributes, it can be less expensive and less time-consuming to formulate polymer blends that combine the desirable properties of each polymer present.

However, most polymer blends, including TPS with polyolefin, are immiscible. PO and TPS form immiscible, phase-separated blends due to the high interfacial tension between the hydrophobic, non-polar PO and the hydrophilic, highly polar TPS. Immiscible blend performance depends not only upon the properties of the individual components but also upon the blend morphology and the interfacial properties between the blend phases. In order to make a uniformly processable blend exhibiting the desired performance characteristics, the blend's morphology and interfacial properties must be advantageously controlled through compatibilization of the polymers.

Compatibilization modifies the interfacial properties of immiscible polymer blends, resulting in reduction of the interfacial tension coefficient, and formation and stabilization of the desired morphology. In effect, compatibilization converts a mixture of polymers into an alloy that has the desired set of performance characteristics. Compatibilized blends are characterized by the presence of a finely dispersed phase, good adhesion between blend phases, strong resistance to phase coalescence, and technologically desirable properties.

Accordingly, it would be desirable to provide compatibilized blends of PO and TPS that are suitable for manufacturing thin packaging films. Further, it would be desirable to provide such blends and films having a high level of bio-based content.

### SUMMARY OF THE INVENTION

The present invention provides a compatibilized thermoplastic polymer-polyolefin composition having from 5% to 95% bio-based content. In one embodiment, the composition comprises: (a) from 5% to 45%, by weight, thermoplastic starch; (b) from 35% to 89%, and in some embodiments from 65% to 89%, by weight, polyolefin; and (c) an effective amount of compatibilizer. The compatibilizer is selected from the group consisting of: (1) polar homopolymers and copolymers with inherent polyolefin compatibility; (2) non-polymeric materials with both polar and non-polar functionality; (3) low molecular weight materials with both polar and non-polar functionality; (4) bulk phase/in-situ compatibilizers; and (5) combinations thereof.

In another embodiment, the composition comprises: (a) from 5% to 99%, or from 5% to 45%, by weight, thermoplastic starch; and (b) from 1% to 95%, or from 55% to 95%, by weight, modified polyolefin, wherein said modified polyolefin functions as the compatibilizer in the composition.

An effective amount of compatibilizer is used. Generally the amount of compatibilizer present, when compatibilizing materials are added to the composition, can be from 15% to 20% based upon the combined weight of the compatibilizer plus TPS. In these embodiments, the ratio of starch to compatibilizer is typically in the range of from 1:20 to 1:2, by weight. In those embodiments where compatibilization is achieved through the modification of the PO itself to function as a compatibilizer, the amount of compatibilizer (i.e., modified PO) can be from 55% to 95%, by weight, of the total composition.

The renewable TPS-polyolefin composition can be made by any suitable method, using any suitable order of mixing. For example, in one embodiment, the method comprises the steps of: (a) mixing, in a molten state, the polyolefin, compatibilizer, and TPS to form an intimate admixture; and (b) cooling the intimate admixture to form a solid TPS-polyolefin composition, which can then be processed into a film. Any suitable mixing device can be used such as, for example, an extruder (e.g., single screw or twin screw). The methods can additionally comprise other steps, such as the step of pelletizing the admixture.

Alternatively, the film can be prepared by blending the polyolefin mixture with a TPS masterbatch or concentrate in an extruder to form a TPS-polyolefin composition, and then extruding the composition to form a film.

In another aspect the present invention pertains to a packaging material or assembly made from the polymeric film composition such as described. The film can be fabricated to be part of a packaging assembly. The packaging assembly can be used to wrap consumer products, such as absorbent articles including diapers, adult incontinence products, pantiliners, feminine hygiene pads, or tissues. In other iterations, the invention relates to a consumer product having a portion made using a flexible polymeric film, such as described. The polymeric film can be incorporated as part of consumer products, e.g., baffle films for adult and feminine care pads and liners, outer cover of diapers or training pants.

Additional features and advantages of the present invention will be revealed in the following detailed description. Both the foregoing summary and the following detailed description and examples are merely representative of the invention, and are intended to provide an overview for understanding the invention as claimed.

### DETAILED DESCRIPTION OF THE INVENTION

The present invention enables manufacturers to make use of a majority of polyolefin compounds to achieve good processing characteristics and mechanical properties at low cost. The present invention describes a composition for and method of making thin packaging and product films for consumer packaged goods with suitable performance, renewable polymer and bio-based polyolefin content to reduce their environmental footprint, and at an attractive cost. The composition incorporates renewable polymers such as thermoplastic starch and alternatively bio-based polyolefins as renewable components. The amount of TPS present should be at a volumetric minority so that the PO's properties will dominate the blend properties. An appropriate type of material at the right amount must be employed to compatibilize the two phases to create an adequate dispersion and good film properties.

It was surprisingly found that a range of intermediate compatibilizer additive compositions allow the blends to be compatibilized and have good physical and mechanical properties. An unexpected region of tertiary composition was found to permit films to form with good mechanical properties and good processability, and for the resultant films to be free from any visible defects. Outside of the compositions, gelled phases of either TPS or compatibilizer formed resulting in poor film mechanical properties and visual defects, thus making the films unsuitable for packaging and product applications. With too little compatibilizer, the renewable polymers (TPS) exist as un-dispersed gels leading to granular defects and visible voids/holes unsuitable for thin packaging or product film applications; at higher than optimal compatibilizer levels, the compatibilizer formed its own gelled phase and resulted in film defects. The other aspect of this invention is that the film material can be processed relatively easily and achieves good tensile strength and cohesive properties that allow packaging and product films to be produced at no productivity penalty or slow down in the converting process. Also disclosed in this invention are multiple-layered co-extruded flexible packaging or product films with one or more layer of the above films and one or more layer of a bio-based and/or petro-based polyolefin, such as polyethylene or mixed polyolefin layers. The presence of a polyolefin layer provides excellent sealability, printability, and mechanical properties required for either packaging or inclusion in consumer packaged goods.

### I. DEFINITIONS

As used herein, the following terms shall have the meaning specified thereafter:
“Bio-based content” refers to the amount of carbon from a renewable resource in a material as a percent of the mass of the total organic carbon in the material, as determined by ASTM D6866-10, method B. Note that any carbon from inorganic sources such as calcium carbonate is not included in determining the bio-based content of the material.
“Bio-based polyolefin” refers to a polyolefin made from a renewable material obtained from one or more intermediate compounds (e.g., sugars, alcohols, organic acids). In turn, these intermediate compounds can be converted to olefin precursors.
“Biodegradable” refers generally to a material that can degrade from the action of naturally occurring microorganisms, such as bacteria, fungi, yeasts, and algae; environmental heat, moisture, or other environmental factors. If desired, the extent of biodegradability may be determined according to ASTM Test Method 5338.92.
“Compatibilizer” means an additive that, when added to a blend of immiscible polymers, modifies their interfaces and stabilizes the blend.
“Effective amount” of compatibilizer means an amount added to a blend of immiscible polymers that sufficiently modifies their interfaces and stabilizes the blend.
“Film” refers to a sheet-like material wherein the length and width of the material far exceed the thickness of the material.
“Monomeric compound” refers to an intermediate compound that may be polymerized to yield a polymer.
“Petro-based polyolefin” refers to a polyolefin derived from petroleum, natural gas, or coal via intermediate olefin precursors.
“Petrochemical” refers to an organic compound derived from petroleum, natural gas, or coal.
“Petroleum” refers to crude oil and its components of paraffinic, cycloparaffinic, and aromatic hydrocarbons. Crude oil may be obtained from tar sands, bitumen fields, and oil shale.
“Polymer” refers to a macromolecule comprising repeat units where the macromolecule has a molecular weight of at least 1000 Daltons. The polymer may be a homopolymer, copolymer, terpoymer etc. The polymer may be produced via free-radical, condensation, anionic, cationic, Ziegler-Natta, metallocene, or ring-opening mechanisms. The polymer may be linear, branched and/or crosslinked.
“Polyethylene” and “polypropylene” refer to polymers prepared from ethylene and propylene, respectively. The polymer may be a homopolymer, or may contain up to about 10 mol % of repeat units from a co-monomer.
“Renewable” refers to a material that can be produced or is derivable from a natural source which is periodically (e.g., annually or perennially) replenished through the actions of plants of terrestrial, aquatic or oceanic ecosystems (e.g., agricultural crops, edible and non-edible grasses, forest products, seaweed, or algae), or microorganisms (e.g., bacteria, fungi, or yeast).
“Renewable resource” refers to a natural resource that can be replenished within a 100 year time frame. The resource may be replenished naturally, or via agricultural techniques. Non-limiting examples of renewable resources include plants (e.g., sugar cane, beets, corn, potatoes, citrus fruit, woody plants, lignocellulosics, hemicellulosics, cellulosic waste), animals, fish, bacteria, fungi, and forestry products. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

### II. POLYOLEFIN

The polyolefins can be derived from renewable resources or from fossil-based materials. The polyolefins derived from renewable resources are bio-based, for example such as bio-produced ethylene and propylene monomers used in the production of polypropylene and polyethylene. These material properties are essentially identical to fossil-based product equivalents, except for the presence of carbon-14 in the bio-based polyolefin.

The polyolefins desirably include polyolefins such as polyethylene or copolymers thereof, including low density, high density, linear low density, or ultra low density polyethylenes such that the polyethylene density ranges from 0.85 grams per cubic centimeter to 0.97 grams per cubic centimeter, or from 0.92 to 0.95 grams per cubic centimeter. The density of the polyethylene is determined by the amount and type of branching and depends on the polymerization technology and co-monomer type. Polypropylene and/or polypropylene copolymers, including atactic polypropylene, isotactic polypropylene, syndiotactic polypropylene, or combinations thereof can also be used. Polypropylene copolymers, especially ethylene, can be used to lower the melting temperature and improve properties. These polypropylene polymers can be produced using metallocene and Ziegler-Natta catalyst systems. These polypropylene and polyethylene compositions can be combined together to custom engineer end-use properties. Polybutylene is also a useful polyolefin.

Biodegradable polyolefins also are contemplated for use herein. Biodegradable materials are susceptible to being assimilated by microorganisms, such as molds, fungi, and bacteria when the biodegradable material is buried in the ground or otherwise contacts the microorganisms (including contact under environmental conditions conducive to the growth of the microorganisms). Suitable biodegradable polymers also include those biodegradable materials that are environmentally-degradable using aerobic or anaerobic digestion procedures, or by virtue of being exposed to environmental elements such as sunlight, rain, moisture, wind, temperature, and the like. The biodegradable thermoplastic polymers can be used individually or as a combination of biodegradable or non-biodegradable polymers.

Non-limiting examples of suitable commercially available polypropylene or polypropylene copolymers include Basell Profax PH835™ (a 35 melt flow rate Ziegler-Natta isotactic polypropylene from Lyondell-Basell), Basell Metocene MF-650W™ (a 500 melt flow rate metallocene isotactic polypropylene from Lyondell-Basell), Polybond 3200™ (a 250 melt flow rate maleic anhydride polypropylene copolymer from Crompton), Exxon Achieve 3854™ (a 25 melt flow rate metallocene isotactic polypropylene from Exxon-Mobil Chemical), and Mosten NB425™ (a 25 melt flow rate Ziegler-Natta isotactic polypropylene from Unipetrol). Other suitable polymers may include; Danimer 27510™ (a polyhydroxyalkanoate polypropylene from Danimer Scientific LLC), Dow Aspun 6811A™ (a 27 melt index polyethylene polypropylene copolymer from Dow Chemical), and Eastman 9921™ (a polyester terephthalic homopolymer with a nominally 0.81 intrinsic viscosity from Eastman Chemical).

The polyolefin component can be a single polymer species as described herein or a blend of two or more polyolefins. If the polymer is polypropylene, the polyolefin can have a melt flow index of greater than 0.5 g/10 min, as measured by ASTM D-1238, used for measuring polypropylene. Other contemplated melt flow indices include greater than 5 g/10 min, greater than 10 g/10 min, or 5 g/10 min to 50 g/10 min.

Bio-based and fossil-based polyolefins can be combined together in the present invention in any ratio, depending on cost and availability. Recycled polyolefins can also be used, alone or in combination with renewable and/or fossil derived polyolefins. The recycled polyolefins can be pre-conditioned to remove any unwanted contaminants prior to compounding or they can be used during the compounding and extrusion process, as well as simply left in the admixture. These contaminants can include trace amounts of other polymers, pulp, pigments, inorganic compounds, organic compounds and other additives typically found in processed polymeric compositions. The contaminants should not negatively impact the final performance properties of the admixture, for example, causing spinning breaks during a fiber spinning process.

For example, the polyolefin can have greater than 10% bio-based content, or greater than 50%, or from 30-100%, or from 1-100% bio-based content (i.e., renewable biobased materials)

### III. THERMOPLASTIC STARCH

As used herein, “thermoplastic starch” or “TPS” means a native starch or a starch derivative that has been rendered destructured and thermoplastic by treatment with one or more plasticizers, with at least one starch plasticizer still remaining. Thermoplastic starch compositions are well known and disclosed in several patents, for example: U.S. Pat. Nos. 5,280,055; 5,314,934; 5,362,777; 5,844,023; 6,214,907; 6,242,102; 6,096,809; 6,218,321; 6,235,815; 6,235,816; and 6,231,970.

Since natural starch generally has a granular structure, it needs to be destructurized before it can be melt processed like a thermoplastic material. For gelatinization, e.g., the process of destructuring the starch, the starch can be destructurized in the presence of a solvent which acts as a plasticizer. The solvent and starch mixture is heated, typically under pressurized conditions and shear to accelerate the gelatinization process. Chemical or enzymatic agents may also be used to destructurize, oxidize, or derivatize the starch. Commonly, starch is destructured by dissolving the starch in water. Fully destructured starch results when the particle size of any remaining undestructured starch does not impact the extrusion process. Any remaining undestructured starch particle sizes are less than 30 μm (by number average), preferably less 15 μm, more preferably less than 5 μm, or less than 2 μm. The residual particle size can be determined by pressing the final formulation into a thin film (50 μm or less) and placing the film into a light microscope under cross polarized light. Under cross polarized light, the signature maltese cross, indicative of undestructured starch, can be observed. If the average size of these particles is above the target range, the destructured starch has not been prepared properly. An alternative process for measuring the amount and size of undestructured starch is by means of a melt filtration test in which a composition containing the starch is passed through a series of screens that can capture residual undestructured starch.

Suitable naturally occurring starches can include, but are not limited to, corn starch, potato starch, sweet potato starch, wheat starch, sago palm starch, tapioca starch, rice starch, soybean starch, arrow root starch, bracken starch, lotus starch, cassaya starch, waxy maize starch, high amylose corn starch, and commercial amylose powder. Blends of starch may also be used. Though all starches are useful herein, the present invention is most commonly practiced with natural starches derived from agricultural sources, which offer the advantages of being abundant in supply, easily replenishable and inexpensive in price. Naturally occurring starches, particularly corn starch, wheat starch, and waxy maize starch, are the preferred starch polymers of choice due to their economy and availability.

Modified starch may also be used. Modified starch is defined as non-substituted or substituted starch that has had its native molecular weight characteristics changed (i.e. the molecular weight is changed but no other changes are necessarily made to the starch). If modified starch is desired, chemical modifications of starch typically include acid or alkali hydrolysis and oxidative chain scission to reduce molecular weight and molecular weight distribution. Natural, unmodified starch generally has a very high average molecular weight and a broad molecular weight distribution (e.g. natural corn starch has an average molecular weight of up to 60,000,000 grams/mole (g/mol)). The average molecular weight of starch can be reduced to the desirable range for the present invention by acid reduction, oxidative reduction, enzymatic reduction, hydrolysis (acid or alkaline catalyzed), physical/mechanical degradation (e.g., via the thermomechanical energy input of the processing equipment), or combinations thereof. The thermomechanical method and the oxidative method offer an additional advantage when carried out in situ. The exact chemical nature of the starch and molecular weight reduction method is not critical as long as the average molecular weight is in an acceptable range.

A plasticizer can be used in the present invention to destructurize the starch and enable the starch to flow, i.e. create a thermoplastic starch. The same plasticizer may be used to increase melt processability or two separate plasticizers may be used. The plasticizers may also improve the flexibility of the final products, which is believed to be due to the lowering of the glass transition temperature of the composition by the plasticizer. The plasticizers should preferably be substantially compatible with the polymeric components of the disclosed compositions so that the plasticizers may effectively modify the properties of the composition. As used herein, the term “substantially compatible” means when heated to a temperature above the softening and/or the melting temperature of the composition, the plasticizer is capable of forming a substantially homogeneous mixture with starch.

Nonlimiting examples of useful hydroxyl plasticizers include sugars such as glucose, sucrose, fructose, raffinose, maltodextrose, galactose, xylose, maltose, lactose, mannose erythrose, glycerol, and pentaerythritol; sugar alcohols such as erythritol, xylitol, malitol, mannitol and sorbitol; polyols such as ethylene glycol, propylene glycol, dipropylene glycol, butylene glycol, hexane triol, and the like, and polymers thereof; and mixtures thereof. Also useful herein are poloxomers and poloxamines. Also suitable for use herein are hydrogen bond forming organic compounds which do not have hydroxyl groups, including urea and urea derivatives; anhydrides of sugar alcohols such as sorbitan; animal proteins such as gelatin; vegetable proteins such as sunflower protein, soybean proteins, cotton seed proteins; and mixtures thereof. Other suitable plasticizers are phthalate esters, dimethyl and diethylsuccinate and related esters, glycerol triacetate, glycerol mono and diacetates, glycerol mono, di, and tripropionates, and butanoates, which are biodegradable. Aliphatic acids such as ethylene acrylic acid, ethylene maleic acid, butadiene acrylic acid, butadiene maleic acid, propylene acrylic acid, propylene maleic acid, and other hydrocarbon based acids. All of the plasticizers may be use alone or in mixtures thereof.

Preferred plasticizers include glycerin, mannitol, and sorbitol, with sorbitol being the most preferred. The amount of plasticizer is dependent upon the molecular weight, amount of starch, and the affinity of the plasticizer for the starch. Generally, the amount of plasticizer increases with increasing molecular weight of starch.

### IV. COMPATIBILIZERS

Compatibilizers must be used to improve dispersion and interfacial interaction between the polar TPS phase and the non-polar polyolefin phase. In such systems where the polyolefin phase is the major component and the TPS phase is the minor component, the compatibilizers are typically included at a level of 25 wt % or less due to their high functionality and associated high cost. These compatibilizers are typically polymeric materials containing both polar and non-polar functionality. The ratio of polar to non-polar functionality on the compatibilizer is typically high (>2 wt % polar functionality). To be most effective, the traditional compatibilizer must migrate to the interface between the TPS and polyolefin. Such migration is limited by thermodynamic and kinetic phenomena. The compatibilizers of the present invention operate more effectively than compatibilizers of the prior art for many reasons depending upon the class.

To improve the compatibility and dispersion characteristics of polar TPS in non-polar polyolefins, several compatibilizers are incorporated in the present invention. The compatibilizers of the present invention fall into four general classifications: (1) polar homopolymers and copolymers with inherent polyolefin compatibility; (2) non-polymeric materials with both polar and non-polar functionality; (3) low molecular weight materials with both polar and non-polar functionality; and (4) bulk phase/in-situ compatibilizers.

An effective amount of compatibilizer is used. Generally the amount of compatibilizer present, when compatibilizing materials are added to the composition, can be from 15% to 20% based upon the combined weight of the compatibilizer plus TPS. In these embodiments, the ratio of starch to compatibilizer is typically in the range of from 1:20 to 1:2, by weight. In those embodiments where compatibilization is achieved through the modification of the PO itself to function as a compatibilizer, the amount of compatibilizer (i.e., modified PO) can be from 1% to 95%, or from 55% to 95%, by weight, of the total composition.

1. Polar Homopolymers and Copolymers with Inherent Polyolefin Compatibility

The compatibilizers of this class may include homopolymers inherently compatible with both the polyolefin and the TPS. Such may include aliphatic polyesters synthesized from ring-opening polymerizations of lactones or lactides such as polycaprolactone. The homopolymers from lactones can be represented by the general formula:

((CH2)nCO2)m

These structures are unique because they are polar but can have favorable interactions with polyolefins. Polycaprolactone is one preferred example. The material is polar but is known in the art to be melt processable and compatible with polyolefins. Other compatibilizers in this class include aliphatic polyamides synthesized from ring-opening polymerizations such as polycaprolactam and polylaurylactam. These are represented by the general formula:

((CH2)nCONH)m

The compatibilizers of the present invention may also include block copolymers of inherently polar monomers such as amides and ethers. These include amide-ether block copolymers such as polycaprolactam block ether (Pebax MH1657) and polylaurylactam block ether (Pebax MV1074).

Other compatibilizers of the present class include aliphatic polyesters obtained from reactions of diacids having two or more carbon atoms such as succinic acid and diols (such as butanediol). Examples include polybutylene succinate.

The efficacy of the compatibilizers in this class can be further improved with addition of typical polyethylene type compatibilizers (5:1 ratio of concentration of compatibilizers of the present class to the typical polyethylene polar copolymer type). For example, the efficacy of the amide-ether block copolymer compatibilizers can be greatly enhanced by combination with polyethylene-acrylic ester-maleic anhydride terpolymer (Lotader 3210) in a 5:1 or less ratio.

2. Non-Polymeric Materials with Both Polar and Non-Polar Functionality

The compatibilizers can be non-polymeric surfactants containing both polar and non-polar functionalities such as fatty acid soaps. Examples include: lipids, epoxidized lipids, castor oil, hydrogenated castor oil, and ethoxylated castor oil. For instance, the oil, wax, or combination thereof can be selected from the group consisting of soy bean oil, epoxidized soy bean oil, maleated soy bean oil, corn oil, cottonseed oil, canola oil, beef tallow, castor oil, coconut, coconut seed oil, corn germ oil, fish oil, linseed oil, olive oil, oiticica oil, palm kernel oil, palm oil, palm seed oil, peanut oil, rapeseed oil, safflower, sperm oil, sunflower seed oil, tall oil, tung oil, whale oil, tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin, capric acid, caproic acid, caprylic acid, lauric acid, lauroleic acid, linoleic acid, linolenic acid, myristic acid, myristoleic acid, oleic acid, palmitic acid, palmitoleic acid, stearic acid, and combinations thereof.

a. Soaps

The term “soap” as used herein refers to fatty acid metal salts that have a softening, phase transition or melting point exhibited by a reduction in crystallinity or an endothermic process upon heating as measured in a differential scanning calorimeter (DSC) from 20° C. to 300° C. For example, the fatty acid salt can be a metal salt having a melting point above 70° C., or above 100° C., or above 140° C. The soap can have a melting point that is lower than the melting temperature of the polyolefin in the composition.

The soap can be present in the composition at a weight percent of 5 wt % to 60 wt %, based upon the total weight of the composition. Other contemplated wt % ranges of soap include 8 wt % to 40 wt %, 10 wt % to 30 wt %, 10 wt % to 20 wt %, or from 12 wt % to 18 wt %, based upon the total weight of the composition.

The soap can be dispersed within the polyolefin such that the soap has a droplet size of less than 10 μm, less than 5 μm, less than 1 μm, or less than 500 nm within the polyolefin. As used herein, the soap and the polymer form an “intimate admixture” when the soap has a droplet size less than 10 μm within the polyolefin. The analytical method for determining droplet size is set forth herein.

The soap can comprise metal salts of fatty acid, such as magnesium stearate, calcium stearate, zinc stearate or combinations thereof. In some embodiments, other soaps may include those derived from metal salts of the following metals found in group 1, 2, 3, 4, 5, 6, 7, 8, 9, 10, 11, 12, 13, 14, 15, 16 of the periodic table of the elements using the IUPAC naming system implemented in 1988; sodium, potassium, rubidium, cesium, silver, cobalt, nickel, copper, manganese, iron, chromium, lithium, lead, thallium, mercury, thorium, and beryllium are examples of some of these metals but are not limited to them. The fatty acid can be selected from a group consisting of carbon-12 to carbon-22 aliphatic chain carboxylic acids, alternatively from carbon-14 to carbon-18. Non-limiting examples of specific fatty acids contemplated include capric acid, caproic acid, caprylic acid, lauric acid, myristic acid, palmitic acid, stearic acid, and mixtures thereof. Exemplary soaps include magnesium stearate, calcium stearate, zinc stearate or combinations thereof. The amount of other metal salt soaps should be less than 50% of the amount of the primary soap, by weight of the primary soap present, or less than 25%, or less than 10%, or less than 5%.

The soap can contain fatty acids derived from various sources. The fatty acid can have a variety of chain lengths. The carbon chain lengths are mostly between C12 and C18, but may contain small fractions (e.g., less than 50 wt %) of other chain lengths. These fatty acids have common names of lauric, myristic, palmitic, stearic, oleic, linoleic, linolenic acids, and includes mixtures thereof. These fatty acids can be saturated, unsaturated, have varying degrees of saturation (e.g., partially saturated), or any variations or combinations thereof. For example, the fatty acids can comprise saturated fatty acids, such as stearic acid. These fatty acids can also be functionalized fatty acids, such as those epoxidized and/or hydroxylated. An example of a functionalized fatty acid is epoxidized oleic acid. An exemplary functionalized fatty acid also includes 12-hydroxystearic acid.

As used herein, the terms “wax” and “oil” describe the sources of the fatty acids used to produce the soap. Non-limiting examples of fatty acids used to produce the soap used in the present invention include beef tallow, castor wax, coconut wax, coconut seed wax, corn germ wax, cottonseed wax, fish wax, linseed wax, olive wax, oiticica wax, palm kernel wax, palm wax, palm seed wax, peanut wax, rapeseed wax, safflower wax, soybean wax, sperm wax, sunflower seed wax, tall wax, tung wax, whale wax, and combinations thereof. Non-limiting examples of specific triglycerides include triglycerides such as, for example, tristearin, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, 1,2-dipalmitolinolein, 1,2-distearo-olein, 1,3-distearo-olein, trimyristin, trilaurin and combinations thereof. Non-limiting examples of specific fatty acids contemplated include capric acid, caproic acid, caprylic acid, lauric acid, myristic acid, palmitic acid, stearic acid, and mixtures thereof. Other specific waxes contemplated include hydrogenated soy bean oil, partially hydrogenated soy bean oil, partially hydrogenated palm kernel oil, and combinations thereof. Inedible waxes from Jatropha and rapeseed oil can also be used. The wax can be selected from the group consisting of a hydrogenated plant oil, a partially hydrogenated plant oil, an epoxidized plant oil, a maleated plant oil, and combinations thereof.

Specific examples of such plant oils include soy bean oil, corn oil, canola oil, and palm kernel oil.

Soaps can be water dispersable or water insoluble. Water dispersible herein means disassociating to form a micellar structure when placed in water or other polar solvent. The test for water dispersable is the same for measuring the amount percent soap described above, except the solvent used is water. If more than 5 weight percent of the soap and less than 50 weight percent is removed in the test, then the soap is water dispersible. Water soluble soaps include sodium and potassium stearate and other metal ions from group 1 metals of the periodic table of the elements. Water insoluble soaps include metal ions from group 2, 3, 4, 5, 6, 7, 8, 9, 10, 11, 12, 13, 14, 15, 16 of the periodic table of the elements using the IUPAC naming system implemented in 1988; examples include magnesium stearate, calcium stearate, and zinc stearate. If 50 weight percent or more of the soap is removed in the water test, then the soap is water soluble.

b. Oils & Waxes

An oil or wax, as used in the disclosed composition, is a lipid. An oil is used to refer to a compound that is liquid at room temperature (e.g., has a melting point of 25° C. or less) while a wax is used to refer to a compound that is a solid at room temperature (e.g., has a melting point of greater than 25° C.). The wax can also have a melting point lower than the melting temperature of the highest volumetric polymer component in the composition. The term wax hereafter can refer to the component either in the solid crystalline state or in the molten state, depending on the temperature. The wax can be solid at a temperature at which the thermoplastic polymer and/or thermoplastic starch are solid. For example, polypropylene is a semicrystalline solid at 90° C., which can be above melting temperature of the wax.

A wax, as used in the disclosed composition, is a lipid having a melting point of greater than 25° C. More preferred is a melting point above 35° C., still more preferred above 45° C. and most preferred above 50° C. The wax can have a melting point that is lower than the melting temperature of the thermoplastic polymer in the composition. The terms “wax” and “oil” are differentiated by crystallinity of the component at or near 25° C. In all cases, the “wax” will have a maximum melting temperature less than the thermoplastic polymer, preferably less than 100° C. and most preferably less than 80° C. The lipid wax can be a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, or combinations thereof. The waxes can be partially or fully hydrogenated materials, or combinations and mixtures thereof, that were formally liquids at room temperature in their unmodified forms. When the temperature is above the melting temperature of the wax, it is a liquid oil. When in the molten state, the wax can be referred to as an “oil”. The terms “wax” and “oil” only have meaning when measured at 25° C. The wax will be a solid at 25° C., while an oil is not a solid at 25° C. Otherwise they are used interchangeably above 25° C.

Non-limiting examples of oils or waxes contemplated in the compositions disclosed herein include beef tallow, castor oil, coconut oil, coconut seed oil, corn germ oil, cottonseed oil, fish oil, linseed oil, olive oil, oiticica oil, palm kernel oil, palm oil, palm seed oil, peanut oil, rapeseed oil, safflower oil, soybean oil, sperm oil, sunflower seed oil, tall oil, tung oil, whale oil, and combinations thereof. Non-limiting examples of specific triglycerides include triglycerides such as, for example, tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin and combinations thereof. Non-limiting examples of specific fatty acids contemplated include capric acid, caproic acid, caprylic acid, lauric acid, lauroleic acid, linoleic acid, linolenic acid, myristic acid, myristoleic acid, oleic acid, palmitic acid, palmitoleic acid, stearic acid, and mixtures thereof. Because the wax may contain a distribution of melting temperatures to generate a peak melting temperature, the wax melting temperature is defined as having a peak melting temperature 25° C. or above as defined as when >50 weight percent of the wax component melts at or above 25° C. This measurement can be made using a differential scanning calorimeter (DSC), where the heat of fusion is equated to the weight percent fraction of the wax.

The oil/wax number average molecular weight, as determined by gel permeation chromatography (GPC), should be less than 2 kDa, preferably less than 1.5 kDa, still more preferred less than 1.2 kDa.

Because the oil/wax may contain a distribution of melting temperatures to generate a peak melting temperature, the oil melting temperature is defined as having a peak melting temperature 25° C. or below as defined when >50 weight percent of the oil component melts at or below 25° C. This measurement can be made using a differential scanning calorimeter (DSC), where the heat of fusion is equated to the weight percent fraction of the oil.

The oil or wax can be from a renewable material (e.g., derived from a renewable resource).

c. Grease

A grease is an intimate admixture comprising a soap and an oil and/or wax. The soap and oil/wax exist in a ratio dispersed within the thermoplastic polymer. The ratio of oil/wax to soap can typically be approximately 1:1, 2:1, 5:1, 10:1, 50:1 or 100:1. The grease intimate admixture is represented by an increased zero shear rate viscosity of the grease vs. the oil/wax in the grease alone. The grease intimate admixture can be prepared before combining with a thermoplastic polymer or simultaneously to preparing the intimate admixture with the thermoplastic polymer.

When the grease is dispersed within the thermoplastic polymer such that the grease droplet size is less than 10 μm, the grease and the polymer are, by definition herein, in “intimate admixture.” The droplet size of the grease within the thermoplastic polymer is a parameter that indicates the level of dispersion of the grease within the thermoplastic polymer. The smaller the droplet size, the higher the dispersion of the grease within the thermoplastic polymer. Conversely, the larger the droplet size the lower the dispersion of the grease within the thermoplastic polymer.

The grease herein has a droplet size of less than 10 μm within the solid thermoplastic polymer. Alternatively, the droplet size can be less than 5 μm, less than 1 μm, or less than 500 nm. The composition can comprise, based upon the total weight of the composition, from 5 wt % to 60 wt % grease, from 8 wt % to 40 wt % grease, or from 10 wt % to 30 wt % grease. Each droplet may contain a range of soap and/or oil/waxes such that a uniform distribution of each component exists within each droplet or each droplet may contain 100% soap and no oil/wax, or a droplet may contain 100% oil/wax and no soap. Preferred are droplets that can both the soap and oil/waxes. It is preferred that more that 10% of the droplets contain that soap and oil/wax, greater than 25%, from 10% to 50%, from 25% to 80% of the droplets contain the oil/wax and soap.

One exemplary way to achieve a suitable dispersion of the grease within the thermoplastic polymer such that they are in intimate admixture is mixing, in a molten state, the thermoplastic polymer and the grease or grease components at a sufficient shear rate. The thermoplastic polymer is melted (e.g., exposed to temperatures greater than the thermoplastic polymer's solidification temperature) to provide the molten thermoplastic polymer and mixed with the grease or grease components. The thermoplastic polymer can be melted prior to addition of the grease or grease components or can be melted in the presence of the grease components (unless specified otherwise, grease and grease components are used interchangeably). It should be understood that when the thermoplastic polymer is melted, the temperature is sufficient that the grease can also be in a liquid crystalline, softened or in the molten state. The term grease as used herein can refer to the component either in the solid (optionally crystalline) state, liquid crystalline, softened or in the molten state, depending on the temperature. It is not required that the grease be solidified at a temperature at which the polymer is solidified. For example, polypropylene is a semi-crystalline solid at 90° C., which is above the melting point of some grease or grease mixtures.

The grease and molten thermoplastic polymer can be mixed using any mechanical means capable of providing the necessary shear rate to result in a composition as disclosed herein. The thermoplastic polymer and grease can be mixed, for example, at a shear rate greater than 10 s⁻¹, or greater than 30 s⁻¹, or from 10 to 10,000 s⁻¹, or from 30 to 10,000 s⁻¹ depending on the forming method (e.g. fiber spinning, film casting/blowing, injection molding, or bottle blowing), to form the intimate admixture The higher the shear rate of the mixing, the greater the dispersion of the grease components in the composition as disclosed herein. Thus, the dispersion can be controlled by selecting a particular shear rate during formation of the composition. Non-limiting examples of suitable mechanical mixing means include a mixer, such as a Haake batch mixer, and an extruder (e.g., a single- or twin-screw extruder).

The polymer-grease composition can further comprise an additive, desirably an additive that is grease soluble or grease dispersible. For example, the additive can be a perfume, dye, pigment, nanoparticle, antistatic agent, filler, or combinations thereof. Other additives can include nucleating agents.

Further, the thermoplastic polymer, the grease, and/or the polymer-grease composition can be sourced from renewable materials (e.g., bio-based). For example, the polymer-grease composition can have greater than 10%, or greater than 50%, or from 30-100%, or from 1-100% bio-based content.

After mixing, the admixture of molten thermoplastic polymer and grease is then rapidly (e.g., in less than 10 seconds) cooled to a temperature lower than the solidification temperature (either via traditional thermoplastic polymer crystallization or passing below the polymer glass transition temperature) of the thermoplastic polymer. The admixture can be cooled to less than 200° C., less than 150° C., less than 100° C. less than 75° C., less than 50° C., less than 40° C., less than 30° C., less than 20° C., less than 15° C., less than 10° C., or to a temperature of 0° C. to 30° C., 0° C. to 20° C., or 0° C. to 10° C. For example, the mixture can be placed in a low temperature liquid (e.g., the liquid is at or below the temperature to which the mixture is cooled) or gas. The liquid can be ambient or controlled temperature water. The gas can be ambient air or controlled temperature and humidity air. Any quenching media can be used so long as it cools the admixture rapidly. Additional liquids such as oils, alcohols and ketones can be used for quenching, along with mixtures comprising water (sodium chloride for example) depending on the admixture composition. Additional gases can be used, such as carbon dioxide and nitrogen, or any other component naturally occurring in atmospheric temperature and pressure air.

Further, the method for making the polymer-grease composition desirably does not comprise the step of removing additive or diluent. The diluent is left behind to realize the benefit of the grease composition. The grease composition is beneficial as the combination of the soap and oil/wax can enable a controllable migration of the grease within the thermoplastic polymer, for example to the solidified polymer surface. The ratio of the soap to oil/wax can be used to engineer the rate of grease migration from zero migration to some desirable amount. One exemplary example is combining calcium stearate with soy bean oil (SBO) into polypropylene. In polymeric compositions containing just SBO and polypropylene, the SBO can migrate to the surface and produce an undesirable feel, for example, at room temperature. Producing a grease composition with SBO and calcium stearate increases the zero shear viscosity of the grease formulation vs. SBO, thereby enabling management of any grease migration to the polymer surface. A second exemplary example is combining magnesium stearate with hydrogenated soy bean oil (HSBO) into polypropylene. HSBO combined into polypropylene without the grease also shows migration of the HSBO to the solidified PP surface at room temperature. An intimate admixture grease of magnesium stearate and HSBO combined into an intimate admixture with polypropylene enable control of the migration of the grease vs. what would results in combining just HSBO into polypropylene.

Optionally, the composition can be made in the form of pellets, which can be used as-is or stored for future use, such as for further processing into the final usable form (e.g., fibers, films, and/or molded articles). The pelletizing step can occur before, during, or after the cooling step. For instance, the pellets can be formed by strand cutting or underwater pelletizing. In strand cutting, the composition is rapidly quenched (generally in a time period much less than 10 seconds) then cut into small pieces. In underwater pelletizing, the mixture is cut into small pieces and simultaneously or immediately thereafter placed in the presence of a low temperature liquid that rapidly cools and solidifies the mixture to form the pelletized composition. Such pelletizing methods are well understood by the ordinarily skilled artisan. Pellet morphologies can be round or cylindrical, and desirably have no dimension larger than 10 mm, or less than 5 mm, or no dimension larger than 2 mm. Alternatively, the admixture (the terms “admixture” and “mixture” are used interchangeably herein) can be used whilst mixed in the molten state and formed directly into fibers or other suitable forms, for example, films, and molded articles.

3. Low Molecular Weight Materials with Both Polar and Non-Polar Functionality

The compatibilizers can also be non-polymer/low molecular weight oligomers or waxes including oxidized waxes such as oxidized, low molecular weight polyethylene, having a weight average molecular weight of less than 10,000, or less than 5,000, an in a particular embodiment from 60 to 10,000. Examples include oxidized polyethylene wax under the trade name KGT 4, available from Jingjiang Concord Plastics Technology Co., Ltd. (Jiangsu, China); AC 316, AC330, and AC395 available from Honeywell Performance Additives, Morristown, N.J., USA; and Epolene™ Series from Westlake Plastics, Houston, Tex., USA.

4. Bulk Phase/In-Situ Compatibilizers

The compatibilizers of the current class can be formed in-situ by modifying the bulk polyolefin phase to be inherently more polar such as through oxidation. This can be accomplished during the final extrusion step to produce the film, fiber, or article, during combination or production of the TPS, or can be completed prior to incorporation with the TPS and/or film, fiber, or article production. This type of compatibilization is characterized by the polar functionality being present on the predominance of polyolefin chains representing the bulk phase, which is unlike traditional compatibilizers with polar functionality where only a minority of the chains in the bulk polyolefin phase actually contain polar functionality.

The modification can be accomplished in a number of ways including peroxide modification, plasma modification, corona modification, and grafting such as anhydride functionality. The modification can also be accomplished by not preventing oxidation through reduced or eliminated usage of anti-oxidants in the various melt processing steps. The bulk polyolefin phase can be oxidized or modified off-line with known methods in the art as referenced in U.S. Pat. Nos. 5,401,811; 3,322,711 issued May 1967 to Bush et al.; 4,459,388 issued July 1984 to Hettche et al.; 4,889,847 issued December 1989 to Schuster et al.; and 5,064,908 issued November 1991 to Schuster et al.

Further, post-reactor grafting of maleic anhydride to bulk polyolefin can result in an embodiment where the grafting per polymer chain is low but overall polar functionality remains sufficient. As disclosed by “Functionalized Polyolefins: Compatibiliser & Coupling Agents for Alloys, Blends & Composites (Devendra Jain), maleic anhydride is reactively grafted after the primary polyolefin is produced. This can be accomplished in the extrusion step where the bulk polyolefin and TPS are combined or formed into a film, fiber, or article.

Additionally, low concentrations of dicumyl peroxide can modify the molecular structure of LLDPE through reactive extrusion, such as disclosed in “Study of low concentrations of dicumyl peroxide on the molecular structure modification of LLDPE by reactive extrusion” (Valeria D. Ramos et al., Polymer Testing, Volume 23, Issue 8, December 2004, Pages 949-955).

Ionizing radiation (e.g., electron beams, gamma rays) can be used to modify polyolefin properties and lead to improved compatibilization. For example, depending upon dosage, electron beams can be used to add functionality to polyolefins by producing cross-links or by creating oxidized regions on the chains. During irradiation, free radicals can be produced by breakage of covalent bonds in the polymer, creating an oxidized polymer surface. Electron beam irradiation can create compatibility by creating strong intermolecular networks. In some embodiments, free radical formation leads to PO cross-linking. Controlled electron beam modifications can also create a compatible interphase around the modified PO. For instance, electron beam irradiation can be used to generate (—OH) and (C═O) surface groups, transforming the once hydrophobic surface into a hydrophilic one.

### V. PROCESS OF MAKING THE COMPOSITIONS

1. Melt Mixing

The polymer, starch, and compatibilizer can be suitably mixed by melting the polyolefin in the presence of the compatibilizer-starch or TPS-compatibilizer components. It should be understood that when the polyolefin is melted, the compatibilizer will also be in the molten state with the optional TPS also in the melt. In the melt state, the polymer, starch, and compatibilizer are subjected to shear which enables a dispersion of the compatibilizer into the polyolefin and/or TPS and/or starch. In the melt state, the oil and/or wax and polymer and/or TPS/starch are significantly more compatible with one other.

The melt mixing of the polyolefin, starch, and compatibilizer can be accomplished in a number of different processes, but processes with high shear are preferred to generate the preferred morphology of the composition. The processes can involve traditional polyolefin processing equipment. The general process order involves adding the polyolefin and starch or TPS components to the system, melting the polyolefin and TPS, and then adding the compatibilizer. However, the materials can be added in any order, depending on the nature of the specific mixing system.

For the exemplified processes, the starch or TPS is prepared in the presence of the polyolefin and compatibilizer. For the exemplified process, the polyolefin and compatibilizer have already been combined. U.S. Pat. Nos. 7,851,391, 6,783,854 and 6,818,295 describe processes for producing TPS. However, starch/TPS can be made in-line and the polyolefin and compatibilizer combined in the same production process to make the compositions as disclosed herein in a single step process. In one exemplary approach, the starch, starch plasticizer and polyolefin are combined first in a twin-screw extruder where the starch is destructured, or optional TPS is formed in the presence of the polyolefin. Later, the compatibilizer is introduced into the starch/TPS/polyolefin mixture via a second feeding location. A second exemplary approach, disclosed in the present application, is to take a compatibilizer already mixed with a polymer and prepare the thermoplastic starch in the presence of the polyolefin containing compatibilizer. A third exemplary approach is to combine a pre-made thermoplastic starch, optionally containing a polyolefin, with a second composition containing a second polyolefin comprising compatibilizer.

Alternatively, the film can be prepared by blending the polyolefin mixture with a TPS masterbatch or concentrate in an extruder to form a TPS-polyolefin composition, and then extruding the composition to form a film.

2. Single Screw Extruder

A single screw extruder is a typical process unit used in most molten polymer extrusion. The single screw extruder typically includes a single shaft within a barrel, the shaft and barrel engineered with certain screw elements (e.g., shapes and clearances) to adjust the shearing profile. A typical RPM range for single screw extruders is 10 to 120. The single screw extruder design is composed of a feed section, compression section, and metering section. In the feed section, using fairly high void volume flights, the polymer is heated and supplied into the compression section, where the melting is completed and the fully molten polymer is sheared. In the compression section, the void volume between the flights is reduced. In the metering section, the polymer is subjected to its highest shearing amount using low void volume between flights. General purpose single screw designs can be used. In this unit, a continuous or steady state type of process is achieved where the composition components are introduced at desired locations, and then subjected to temperatures and shear within target zones. The process can be considered to be a steady state process as the physical nature of the interaction at each location in the single screw process is constant as a function of time. This allows for optimization of the mixing process by enabling a zone-by-zone adjustment of the temperature and shear, where the shear can be changed through the screw elements and/or barrel design or screw speed.

The mixed composition exiting the single screw extruder can then be pelletized via extrusion of the melt into a liquid cooling medium, for example water, and then the polymer strand can be cut into small pieces or pellets. Alternatively, the mixed composition can be used to produce the final formed structure, for example fibers. There are two basic types of molten polymer pelletization process used in polymer processing: strand cutting and underwater pelletization. In strand cutting the composition is rapidly quenched (generally in much less than 10 seconds) in the liquid medium, then cut into small pieces. In the underwater pelletization process, the molten polymer is cut into small pieces then simultaneously or immediately thereafter placed in the presence of a low temperature liquid that rapidly quenches and crystallizes the polymer. These methods are commonly known and used within the polymer processing industry.

The polymer strands that come from the extruder are rapidly placed into a water bath, most often having a temperature range of 1° C. to 50° C. (e.g., normally at room temperature, which is 25° C.). An alternate end use for the mixed composition is further processing into the desired structure, for example fiber spinning and film or injection molding. The single screw extrusion process can provide for a high level of mixing and high quench rate. A single screw extruder also can be used to further process a pelletized composition into fibers and injection molded articles. For example, the fiber single screw extruder can be a 37 mm system with a standard general purpose screw profile and a 30:1 length to diameter ratio.

3. Twin Screw Extruder

A twin screw extruder is the typical unit used in most molten polymer extrusion where high intensity mixing is required. The twin screw extruder includes two shafts and an outer barrel. A typical RPM range for twin screw extruders is 10 to 1200. The two shafts can be co-rotating or counter rotating and allow for close tolerance, high intensity mixing. In this type of unit, a continuous or steady state type of process is achieved where the composition components are introduced at desired locations along the screws, and subjected to high temperatures and shear within target zones. The process can be considered to be a steady state process as the physical nature of the interaction at each location in the twin screw process is constant as a function of time. This allows for optimization of the mixing process by enabling a zone-by-zone adjustment of the temperature and shear, where the shear can be changed through the screw elements and/or barrel design.

The mixed composition at the end of the twin screw extruder can then be pelletized via extrusion of the melt into a liquid cooling medium, often water, and then the polymer strand is cut into small pieces or pellets. Alternatively, the mixed composition can be used to produce the final formed structure, for example fibers. There are two basic types of molten polymer pelletization processes used in polymer processing, namely strand cutting and underwater pelletization. In strand cutting the composition is rapidly quenched (generally in much less than 10 s) in the liquid medium then cut into small pieces. In the underwater pelletization process, the molten polymer is cut into small pieces then simultaneously or immediately thereafter placed in the presence of a low temperature liquid that rapidly quenches and crystallizes the polymer. An alternate end use for the mixed composition is direct further processing into filaments or fibers via spinning of the molten admixture accompanied by cooling.

One screw profile can be employed using a Baker Perkins CT-25 25 mm corotating 52:1 length to diameter ratio system. This specific CT-25 is composed of 11 zones where the temperature can be controlled, as well as the die temperature. Four liquid injection sites are also possible, located between zone 1 and 2 (location A), zone 2 and 3 (location B), zone 5 and 6 (location C). and zone 7 and 8 (location D).

The liquid injection location is not heated directly, but rather indirectly through the adjacent heated zone. Locations A, B, C, and D can be used to inject the compatibilizer, or the compatibilizer can be added in the beginning along with the polyolefin. A side feeder for adding additional solids or a vent can be included between Zone 6 and Zone 7. Zone 10 contains a vacuum for removing any residual vapor, as needed. Unless noted otherwise, the compatibilizer is added in Zone 1. Alternatively, the compatibilizer is melted via a glue tank and supplied to the twin-screw via a heated hose. Both the glue tank and the supply hose are heated at a temperature greater than the melting point of the compatibilizer (e.g., 170° C.).

Two types of regions, conveyance and mixing, are used in the CT-25. In the conveyance region, the materials are heated (including thorough melting in Zone 1 into Zone 2 if needed) and conveyed along the length of the barrel, under low to moderate shear. The mixing section contains special elements that dramatically increase shear and mixing. The length and location of the mixing sections can be changed as needed to increase or decrease shear as needed.

The standard mixing screw for the CT-25 is composed of two mixing sections. The first mixing section is located in zone 3 to 5 and is one RKB 45/5/36 then two RKB45/5/24 followed by two RKB 45/5/12, a reversing RKB 45/5/12 LH (left handed), then 10 RKB 45/5/12 and then a reversing element RSE 24/12 LH followed by conveyance into the second mixing section using five RSE36/36 elements. Prior to the second mixing section is one RSE 24/24 and two RSE 16/16 (right handed conveyance element with 16 mm pitch and 16 mm total element length) elements are used to increase pumping into the second mixing region. The second mixing region, located in zone 7 and zone 8, is one RKB 45/5/36 then two RKB45/5/24 followed by six RKB 45/5/12 and then a full reversing element SE 24/12 LH. The combination of the SE 16/16 elements in front of the mixing zone and single reversing elements greatly increases the shear and mixing. The remaining screw elements are conveyance elements.

An additional screw element type is a reversing element, which can increase the filling level in that part of the screw and provide better mixing. Twin screw compounding is a mature field. One skilled in the art can consult books for proper mixing and dispersion. These types of screw extruders are well understood in the art and a general description can be found in: Twin Screw Extrusion 2E: Technology and Principles by James White from Hansen Publications. Although specific examples are given for mixing, many different combinations are possible using various element configurations to achieve the needed level of mixing to form the intimate admixtures.

A second compounding system can be used to prepare the mixed composition. A second screw profile can be employed using a Warner & Pfleiderer 30 mm (WP-30) corotating 48:1 length to diameter ratio system. This specific WP-30 is composed of 12 zones where the temperature can be controlled, as well as the die temperature. Materials are fed into the extruder in Zone 1. A vent is located in Zone 11.

The exact nature of the extruder and screw design are not as critical so long as the composition can be mixed, for example, at a shear rate greater than 10 s⁻¹, or greater than 30 s⁻¹, or from 10 to 10,000 s⁻¹, or from 30 to 10,000 s⁻¹ depending on the forming method (e.g. fiber spinning, film casting/blowing, injection molding, or bottle blowing), to form the intimate admixture The higher the shear rate of the mixing, the greater the dispersion in the composition as disclosed herein. Thus, the dispersion can be controlled by selecting a particular shear rate during formation of the composition.

### VI. FLEXIBLE THIN FILMS AND ARTICLES OF MANUFACTURE

The composition of the present invention can be used to make articles in a variety of forms, including films, fibers, and molded objects. As used herein, “article” refers to the composition in its hardened state at or near 25° C. The articles can be used in their present form (e.g., a bottle, an automotive part, a component of an absorbent hygiene product), or can be used for subsequent re-melt and/or manufacture into other articles (e.g., pellets, fibers).

Flexible thin films that can be made from the present inventive compositions and methods of making are set forth herein.

1. Films

A composition as disclosed herein can be formed into a film and can comprise one of many different configurations, depending on the film properties desired. The properties of the film can be manipulated by varying, for example, the thickness, or in the case of multilayered films, the number of layers, the chemistry of the layers, i.e., hydrophobic or hydrophilic, and the types of polymers used to form the polymeric layers. The films disclosed herein can have a thickness of less than 300 μm, or can have a thickness of 300 μm or greater. Typically, when films have a thickness of 300 μm or greater, they are referred to as extruded sheets, but it is understood that the films disclosed herein embrace both films (e.g., with thicknesses less than 300 μm) and extruded sheets (e.g., with thicknesses of 300 μm or greater).

The films disclosed herein can be multi-layer films. The film can have at least two layers (e.g., a first film layer and a second film layer). The first film layer and the second film layer can be layered adjacent to each other to form the multi-layer film. A multi-layer film can have at least three layers (e.g., a first film layer, a second film layer and a third film layer). The second film layer can at least partially overlie at least one of an upper surface or a lower surface of the first film layer. The third film layer can at least partially overlie the second film layer such that the second film layer forms a core layer. It is contemplated that multi-layer films can include additional layers (e.g., binding layers, non-permeable layers, etc.).

It will be appreciated that multi-layer films can comprise from 2 layers to 1000 layers; or from 3 layers to 200 layers; or from 5 layers to 100 layers.

The films disclosed herein can have a thickness (e.g., caliper) from 10 microns to 200 microns; in certain or from 20 microns to 100 microns; or from 40 microns to 60 microns. For example, in the case of multi-layer films, each of the film layers can have a thickness less than 100 microns, or less than 50 microns, or less than 10 microns, or from 10 microns to 300 microns. It will be appreciated that the respective film layers can have substantially the same or different thicknesses.

Thickness of the films can be evaluated using various techniques, including the methodology set forth in ISO 4593:1993, Plastics—Film and sheeting—Determination of thickness by mechanical scanning. It will be appreciated that other suitable methods may be available to measure the thickness of the films described herein.

For multi-layer films, each respective layer can be formed from a composition described herein. The selection of compositions used to form the multi-layer film can have an impact on a number of physical parameters, and as such, can provide improved characteristics such as lower basis weights and higher tensile and seal strengths. Examples of commercial multi-layer films with improved characteristics are described in U.S. Pat. No. 7,588,706.

A multi-layer film can include a 3-layer arrangement wherein a first film layer and a third film layer form the skin layers and a second film layer is formed between the first film layer and the third film layer to form a core layer. The third film layer can be the same or different from the first film layer, such that the third film layer can comprise a composition as described herein. It will be appreciated that similar film layers could be used to form multi-layer films having more than 3 layers. For multi-layer films, it is contemplated having different concentration of the composition described herein in different layers. One technique for using multi-layer films is to control the location of the composition described herein. For example, in a 3 layer film, the core layer may contain the composition described herein while the outer layer does not. Alternatively, the inner layer may not contain the composition described herein and the outer layers do contain the composition described herein.

If incompatible layers are to be adjacent in a multi-layer film, a tie layer can desirably be positioned between them. The purpose of the tie layer is to provide a transition and adequate adhesion between incompatible materials. An adhesive or tie layer is typically used between layers of layers that exhibit delamination when stretched, distorted, or deformed. The delamination can be either microscopic separation or macroscopic separation. In either event, the performance of the film may be compromised by this delamination. Consequently, a tie layer that exhibits adequate adhesion between the layers is used to limit or eliminate this delamination.

A tie layer is generally useful between incompatible materials. For instance, when a polyolefin and a copoly(ester-ether) are the adjacent layers, a tie layer is generally useful.

The tie layer is chosen according to the nature of the adjacent materials, and is compatible with and/or identical to one material (e.g. nonpolar and hydrophobic layer) and a reactive group which is compatible or interacts with the second material (e.g. polar and hydrophilic layer).

Suitable backbones for the tie layer include polyethylene (low density—LDPE, linear low density—LLDPE, high density—HDPE, and very low density—VLDPE) and polypropylene.

The reactive group may be a grafting monomer that is grafted to this backbone, and is or contains at least one alpha- or beta-ethylenically unsaturated carboxylic acid or anhydrides, or a derivative thereof. Examples of such carboxylic acids and anhydrides, which may be mono-, di-, or polycarboxylic acids, are acrylic acid, methacrylic acid, maleic acid, fumaric acid, itaconic acid, crotonic acid, itaconic anhydride, maleic anhydride, and substituted malic anhydride, e.g. dimethyl maleic anhydride. Examples of derivatives of the unsaturated acids are salts, amides, imides and esters e.g. mono- and disodium maleate, acrylamide, maleimide, and diethyl fumarate.

A particularly preferred tie layer is a low molecular weight polymer of ethylene with 0.1 to 30 weight percent of one or more unsaturated monomers which can be copolymerized with ethylene, e.g., maleic acid, fumaric acid, acrylic acid, methacrylic acid, vinyl acetate, acrylonitrile, methacrylonitrile, butadiene, carbon monoxide, etc. Preferred are acrylic esters, maleic anhydride, vinyl acetate, and methyacrylic acid. Anhydrides are particularly preferred as grafting monomers with maleic anhydride being most preferred.

An exemplary class of materials suitable for use as a tie layer is a class of materials known as anhydride modified ethylene vinyl acetate sold by DuPont under the tradename Bynel®, e.g., Bynel® 3860. Another material suitable for use as a tie layer is an anhydride modified ethylene methyl acrylate also sold by DuPont under the tradename Bynel®, e.g., Bynel® 2169. Maleic anhydride graft polyolefin polymers suitable for use as tie layers are also available from Elf Atochem North America, Functional Polymers Division, of Philadelphia, Pa. as Orevac™.

Alternatively, a polymer suitable for use as a tie layer material can be incorporated into the composition of one or more of the layers of the films as disclosed herein. By such incorporation, the properties of the various layers are modified so as to improve their compatibility and reduce the risk of delamination.

Other intermediate layers besides tie layers can be used in the multi-layer film disclosed herein. For example, a layer of a polyolefin composition can be used between two outer layers of a hydrophilic resin to provide additional mechanical strength to the extruded web. Any number of intermediate layers may be used.

Examples of suitable thermoplastic materials for use in forming intermediate layers include polyethylene resins such as low density polyethylene (LDPE), linear low density polyethylene (LLDPE), ethylene vinyl acetate (EVA), ethylene methyl acrylate (EMA), polypropylene, and poly(vinyl chloride). Preferred polymeric layers of this type have mechanical properties that are substantially equivalent to those described above for the hydrophobic layer.

In addition to being formed from the compositions described herein, the films can further include additional additives. For example, opacifying agents can be added to one or more of the film layers. Such opacifying agents can include iron oxides, carbon black, aluminum, aluminum oxide, titanium dioxide, talc and combinations thereof. These opacifying agents can comprise 0.1% to 5% by weight of the film, or 0.3% to 3% of the film. It will be appreciated that other suitable opacifying agents can be employed and in various concentrations. Examples of opacifying agents are described in U.S. Pat. No. 6,653,523.

Furthermore, the films can comprise other additives, such as other polymers materials (e.g., a polypropylene, a polyethylene, a ethylene vinyl acetate, a polymethylpentene any combination thereof, or the like), a filler (e.g., glass, talc, calcium carbonate, or the like), a mold release agent, a flame retardant, an electrically conductive agent, an anti-static agent, a pigment, an antioxidant, an impact modifier, a stabilizer (e.g., a UV absorber), wetting agents, dyes, a film anti-static agent or any combination thereof. Film antistatic agents include cationic, anionic, and, nonionic agents. Cationic agents include ammonium, phosphonium and sulphonium cations, with alkyl group substitutions and an associated anion such as chloride, methosulphate, or nitrate. Anionic agents contemplated include alkylsulphonates. Nonionic agents include polyethylene glycols, organic stearates, organic amides, glycerol monostearate (GMS), alkyl di-ethanolamides, and ethoxylated amines.

2. Method of Making Films

The film as disclosed herein can be processed using conventional procedures for producing films on conventional coextruded film-making equipment. In general, polymers can be melt processed into films using either cast or blown film extrusion methods both of which are described in Plastics Extrusion Technology—2nd Ed., by Allan A. Griff (Van Nostrand Reinhold-1976).

Cast film is extruded through a linear slot die. Generally, the flat web is cooled on a large moving polished metal roll (chill roll). It quickly cools, and peels off the first roll, passes over one or more auxiliary rolls, then through a set of rubber-coated pull or “haul-off” rolls, and finally to a winder.

In blown film extrusion, the melt is extruded upward through a thin annular die opening. This process is also referred to as tubular film extrusion. Air is introduced through the center of the die to inflate the tube and causes it to expand. A moving bubble is thus formed which is held at constant size by simultaneous control of internal air pressure, extrusion rate, and haul-off speed. The tube of film is cooled by air blown through one or more chill rings surrounding the tube. The tube is next collapsed by drawing it into a flattened frame through a pair of pull rolls and into a winder.

A coextrusion process requires more than one extruder and either a coextrusion feedblock or a multi-manifold die system or combination of the two to achieve a multilayer film structure. U.S. Pat. Nos. 4,152,387 and 4,197,069, incorporated herein by reference, disclose the feedblock and multi-manifold die principle of coextrusion. Multiple extruders are connected to the feedblock which can employ moveable flow dividers to proportionally change the geometry of each individual flow channel in direct relation to the volume of polymer passing through the flow channels. The flow channels are designed such that, at their point of confluence, the materials flow together at the same velocities and pressure, minimizing interfacial stress and flow instabilities. Once the materials are joined in the feedblock, they flow into a single manifold die as a composite structure. Other examples of feedblock and die systems are disclosed in Extrusion Dies for Plastics and Rubber, W. Michaeli, Hanser, N.Y., 2nd Ed., 1992, hereby incorporated herein by reference. It may be important in such processes that the melt viscosities, normal stress differences, and melt temperatures of the material do not differ too greatly. Otherwise, layer encapsulation or flow instabilities may result in the die leading to poor control of layer thickness distribution and defects from non-planar interfaces (e.g. fish eye) in the multilayer film.

An alternative to feedblock coextrusion is a multi-manifold or vane die as disclosed in U.S. Pat. Nos. 4,152,387, 4,197,069, and 4,533,308, incorporated herein by reference. Whereas in the feedblock system melt streams are brought together outside and prior to entering the die body, in a multi-manifold or vane die each melt stream has its own manifold in the die where the polymers spread independently in their respective manifolds. The melt streams are married near the die exit with each melt stream at full die width. Moveable vanes provide adjustability of the exit of each flow channel in direct proportion to the volume of material flowing through it, allowing the melts to flow together at the same velocity, pressure, and desired width.

Since the melt flow properties and melt temperatures of polymers vary widely, use of a vane die has several advantages. The die lends itself toward thermal isolation characteristics wherein polymers of greatly differing melt temperatures, for example up to 175° F. (80° C.), can be processed together.

Each manifold in a vane die can be designed and tailored to a specific polymer. Thus the flow of each polymer is influenced only by the design of its manifold, and not forces imposed by other polymers. This allows materials with greatly differing melt viscosities to be coextruded into multilayer films. In addition, the vane die also provides the ability to tailor the width of individual manifolds, such that an internal layer can be completely surrounded by the outer layer leaving no exposed edges. The feedblock systems and vane dies can be used to achieve more complex multilayer structures.

One of skill in the art will recognize that the size of an extruder used to produce the films as disclosed herein depends on the desired production rate and that several sizes of extruders may be used. Suitable examples include extruders having a 1 inch (2.5 cm) to 1.5 inch (3.7 cm) diameter with a length/diameter ratio of 24 or 30. If required by greater production demands, the extruder diameter can range upwards. For example, extruders having a diameter between 2.5 inches (6.4 cm) and 4 inches (10 cm) can be used to produce the films of the present invention. A general purpose screw may be used. A suitable feedblock is a single temperature zone, fixed plate block. The distribution plate is machined to provide specific layer thicknesses. For example, for a three layer film, the plate provides layers in an 80/10/10 thickness arrangement, a suitable die is a single temperature zone flat die with “flex-lip” die gap adjustment. The die gap is typically adjusted to be less than 0.020 inches (0.5 mm) and each segment is adjusted to provide for uniform thickness across the web. Any size die may be used as production needs may require, however, 10-14 inch (25-35 cm) dies have been found to be suitable. The chill roll is typically water-cooled. Edge pinning is generally used and occasionally an air knife may be employed.

For some coextruded films, the placement of a tacky hydrophilic material onto the chill roll may be necessary. When the arrangement places the tacky material onto the chill roll, release paper may be fed between the die and the chill roll to minimize contact of the tacky material with the rolls. However, a preferred arrangement is to extrude the tacky material on the side away from the chill roll. This arrangement generally avoids sticking material onto the chill roll. An extra stripping roll placed above the chill roll may also assist the removal of tacky material and also can provide for additional residence time on the chill roll to assist cooling the film.

Occasionally, tacky material may stick to downstream rolls. This problem may be minimized by either placing a low surface energy (e.g. Teflon®) sleeve on the affected rolls, wrapping Teflon® tape on the effected rolls, or by feeding release paper in front of the effected rolls. Finally, if it appears that the tacky material may block to itself on the wound roll, release paper may be added immediately prior to winding. This is a standard method of preventing blocking of film during storage on wound rolls. Processing aids, release agents or contaminants should be minimized. In some cases, these additives can bloom to the surface and reduce the surface energy (raise the contact angle) of the hydrophilic surface.

An alternative method of making the multi-layer films as disclosed herein is to extrude a web comprising a material suitable for one of the individual layers. Extrusion methods as known to the art for forming flat films are suitable. Such webs may then be laminated to form a multi-layer film suitable for formation into a fluid pervious web using the methods discussed below. As will be recognized, a suitable material, such as a hot melt adhesive, can be used to join the webs to form the multi-layer film. A preferred adhesive is a pressure sensitive hot melt adhesive such as a linear styrene isoprene styrene (“SIS”) hotmelt adhesive, but it is anticipated that other adhesives, such as polyester of polyamide powdered adhesives, hotmelt adhesives with a compatibilizer such as polyester, polyamide or low residual monomer polyurethanes, other hotmelt adhesives, or other pressure sensitive adhesives could be utilized in making the multi-layer films of the present invention.

In another alternative method of making the films as disclosed herein, a base or carrier web can be separately extruded and one or more layers can be extruded thereon using an extrusion coating process to form a film. Desirably, the carrier web passes under an extrusion die at a speed that is coordinated with the extruder speed so as to form a very thin film having a thickness of less than 25 microns. The molten polymer and the carrier web are brought into intimate contact as the molten polymer cools and bonds with the carrier web.

As noted above, a tie layer may enhance bonding between the layers. Contact and bonding are also normally enhanced by passing the layers through a nip formed between two rolls. The bonding may be further enhanced by subjecting the surface of the carrier web that is to contact the film to surface treatment, such as corona treatment, as is known in the art and described in Modern Plastics Encyclopedia Handbook, p. 236 (1994).

If a monolayer film layer is produced via tubular film (i.e., blown film techniques) or flat die (i.e., cast film) as described by K. R. Osborn and W. A. Jenkins in “Plastic Films, Technology and Packaging Applications” (Technomic Publishing Co., Inc. (1992)), then the film can go through an additional post-extrusion step of adhesive or extrusion lamination to other packaging material layers to form a multi-layer film. If the film is a coextrusion of two or more layers, the film can still be laminated to additional layers of packaging materials, depending on the other physical requirements of the final film. “Laminations Vs. Coextrusion” by D. Dumbleton (Converting Magazine (September 1992), also discusses lamination versus coextrusion.

### VII. ADDITIVES

The compositions disclosed herein can further include any suitable additive(s) as desired. Non-limiting examples of classes of additives contemplated in the compositions disclosed herein include perfumes, dyes, pigments, nanoparticles, antistatic agents, fillers, and combinations thereof. The compositions disclosed herein can contain a single additive or a mixture of additives. For example, both a perfume and a colorant (e.g., pigment and/or dye) can be present in the composition. The additive(s), when present, is/are typically present in a weight percent of 0.05 wt % to 20 wt %, or 0.1 wt % to 10 wt %, based upon the total weight of the composition.

As used herein the term “perfume” is used to indicate any odoriferous material that is subsequently released from the composition as disclosed herein. A wide variety of chemicals are known for perfume uses, including materials such as aldehydes, ketones, alcohols, and esters. More commonly, naturally occurring plant and animal oils and exudates including complex mixtures of various chemical components are known for use as perfumes. The perfumes herein can be relatively simple in their compositions or can include highly sophisticated complex mixtures of natural and/or synthetic chemical components, all chosen to provide any desired odor. Typical perfumes can include, for example, woody/earthy bases containing exotic materials, such as sandalwood, civet and patchouli oil. The perfumes can be of a light floral fragrance (e.g. rose extract, violet extract, and lilac). The perfumes can also be formulated to provide desirable fruity odors, e.g. lime, lemon, and orange. The perfumes delivered in the compositions and articles of the present invention can be selected for an aromatherapy effect, such as providing a relaxing or invigorating mood. As such, any material that exudes a pleasant or otherwise desirable odor can be used as a perfume active in the compositions and articles of the present invention.

A pigment or dye can be inorganic, organic, or a combination thereof. Specific examples of pigments and dyes contemplated include pigment Yellow (C.I. 14), pigment Red (C.I. 48:3), pigment Blue (C.I. 15:4), pigment Black (C.I. 7), and combinations thereof. Specific contemplated dyes include water soluble ink colorants like direct dyes, acid dyes, base dyes, and various solvent soluble dyes. Examples include, but are not limited to, FD&C Blue 1 (C.I. 42090:2), D&C Red 6(C.I. 15850), D&C Red 7(C.I. 15850:1), D&C Red 9(C.I. 15585:1), D&C Red 21(C.I. 45380:2), D&C Red 22(C.I. 45380:3), D&C Red 27(C.I. 45410:1), D&C Red 28(C.I. 45410:2), D&C Red 30(C.I. 73360), D&C Red 33(C.I. 17200), D&C Red 34(C.I. 15880:1), and FD&C Yellow 5(C.I. 19140:1), FD&C Yellow 6(C.I. 15985:1), FD&C Yellow 10(C.I. 47005:1), D&C Orange 5(C.I. 45370:2), and combinations thereof.

Contemplated fillers include, but are not limited to, inorganic fillers such as, for example, the oxides of magnesium, aluminum, silicon, and titanium. These materials can be added as inexpensive fillers or processing aides. Other inorganic materials that can function as fillers include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, phosphate salts, can be used. Additionally, alkyd resins can also be added to the composition. Alkyd resins can comprise a polyol, a polyacid or anhydride, and/or a fatty acid.

Additional contemplated additives include nucleating and clarifying agents for the thermoplastic polymer. Specific examples, suitable for polypropylene, for example, are benzoic acid and derivatives (e.g., sodium benzoate and lithium benzoate), as well as kaolin, talc and zinc glycerolate. Dibenzlidene sorbitol (DBS) is an example of a clarifying agent that can be used. Other nucleating agents that can be used are organocarboxylic acid salts, sodium phosphate and metal salts (e.g., aluminum dibenzoate). In one aspect, the nucleating or clarifying agents can be added in the range from 20 parts per million (20 ppm) to 20,000 ppm, or from 200 ppm to 2000 ppm, or from 1000 ppm to 1500 ppm. The addition of the nucleating agent can be used to improve the tensile and impact properties of the finished composition.

Contemplated surfactants include anionic surfactants, amphoteric surfactants, or a combination of anionic and amphoteric surfactants, and combinations thereof, such as surfactants disclosed, for example, in U.S. Pat. Nos. 3,929,678 and 4,259,217 and in EP 414 549, WO93/08876 and WO93/08874.

Contemplated nanoparticles include metals, metal oxides, allotropes of carbon, clays, organically modified clays, sulfates, nitrides, hydroxides, oxy/hydroxides, particulate water-insoluble polymers, silicates, phosphates and carbonates. Examples include silicon dioxide, carbon black, graphite, grapheme, fullerenes, expanded graphite, carbon nanotubes, talc, calcium carbonate, betonite, montmorillonite, kaolin, zinc glycerolate, silica, aluminosilicates, boron nitride, aluminum nitride, barium sulfate, calcium sulfate, antimony oxide, feldspar, mica, nickel, copper, iron, cobalt, steel, gold, silver, platinum, aluminum, wollastonite, aluminum oxide, zirconium oxide, titanium dioxide, cerium oxide, zinc oxide, magnesium oxide, tin oxide, iron oxides (Fe₂O₃, Fe₃O₄) and mixtures thereof. Nanoparticles can increase strength, thermal stability, and/or abrasion resistance of the compositions disclosed herein, and can give the compositions electric properties.

Anti-static agents include fabric softeners that are known to provide antistatic benefits. This can include those fabric softeners having a fatty acyl group that has an iodine value of greater than 20, such as N,N-di(tallowoyl-oxy-ethyl)-N,N-dimethyl ammonium methylsulfate.

### IIX. VALIDATION OF POLYMERS DERIVED FROM RENEWABLE RESOURCES

A suitable validation technique is through ¹⁴C analysis. A small amount of the carbon dioxide in the atmosphere is radioactive. This ¹⁴C carbon dioxide is created when nitrogen is struck by an ultra-violet light produced neutron, causing the nitrogen to lose a proton and form carbon of molecular weight 14 which is immediately oxidized to carbon dioxide. This radioactive isotope represents a small but measurable fraction of atmospheric carbon. Atmospheric carbon dioxide is cycled by green plants to make organic molecules during photosynthesis. The cycle is completed when the green plants or other forms of life metabolize the organic molecules, thereby producing carbon dioxide which is released back to the atmosphere. Virtually all forms of life on Earth depend on this green plant production of organic molecules to grow and reproduce. Therefore, the ¹⁴C that exists in the atmosphere becomes part of all life forms and their biological products. In contrast, fossil fuel based carbon does not have the signature radiocarbon ratio of atmospheric carbon dioxide.

Assessment of the renewably based carbon in a material can be performed through standard test methods. Using radiocarbon and isotope ratio mass spectrometry analysis, the bio-based content of materials can be determined. ASTM International, formally known as the American Society for Testing and Materials, has established a standard method for assessing the bio-based content of materials. The ASTM method is designated ASTM D6866-10.

The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, for example, it would give a radiocarbon signature near 54 pMC (assuming the petroleum derivatives have the same percentage of carbon as the soybeans).

A biomass content result is derived by assigning 100% equal to 107.5 pMC and 0% equal to 0 pMC. In this regard, a sample measuring 99 pMC will give an equivalent bio-based content value of 92%.

Assessment of the materials described herein was done in accordance with ASTM D6866. The mean values quoted in this report encompasses an absolute range of 6% (plus and minus 3% on either side of the bio-based content value) to account for variations in end-component radiocarbon signatures. It is presumed that all materials are present day or fossil in origin and that the desired result is the amount of bio-based component “present” in the material, not the amount of bio-based material “used” in the manufacturing process.

In one embodiment, a polyolefin film has a bio-based content from about 5% to about 95% using ASTM D6866-10, method B. In another embodiment, a polyolefin film has a bio-based content value from about 20% to about 90% using ASTM D6866-10, method B. In yet another embodiment, a polyolefin film has a bio-based content value from about 50% to about 90% using ASTM D6866-10, method B.

In order to apply the methodology of ASTM D6866-10 to determine the bio-based content of a polyolefin film, a representative sample of the component must be obtained for testing. In one embodiment, a representative portion of the polyolefin film can be ground into particulates less than about 20 mesh using known grinding methods (e.g., Wiley® mill), and a representative sample of suitable mass taken from the randomly mixed particles.

### IV. ILLUSTRATIVE CONSUMER PRODUCTS

The present thermoplastic film materials can be used to make packaging for various kinds of consumer products in general terms. For purpose of illustration, certain package embodiments may be bags or wraps for consumer products such as absorbent articles (e.g., baby diapers or feminine hygiene articles), facial tissues, and paper towels, as well as products including garbage bags, plastic grocery bags, kitchen wraps, food storage bags, floral wraps, commercial grocery wrap, agricultural barriers, vegetable packaging, meat packaging, bakery packaging, and food catering packaging.

### EXAMPLES

The following examples further describe and demonstrate typical embodiments within the scope of the present invention. The examples are given solely for the purpose of illustration and are not to be construed as limitations of the present invention since many variations thereof are possible without departing from the spirit and scope of the invention. Ingredients are identified by chemical name, or otherwise defined below.

All examples are produced using the following method: A Baker Perkins CT-25 25 mm corotating 52:1 length to diameter ratio system is used to prepare all material shown in the examples. This specific CT-25 is composed of 11 zones where the temperature can be controlled, as well as the die temperature. Four liquid injection sites are also possible, located between zone 1 and 2 (location A), zone 2 and 3 (location B), zone 5 and 6 (location C) and zone 7 and 8 (location D).

The liquid injection location is not heated directly, but rather indirectly through the adjacent heated zone. Locations A, B, C, and D can be used to inject the compatibilizer, or the compatibilizer can be added in the beginning along with the polyolefin. A side feeder for adding additional solids or a vent can be included between Zone 6 and Zone 7. Zone 10 contains a vacuum for removing any residual vapor, as needed. Unless noted otherwise, the compatibilizer is added in Zone 1. Alternatively, the compatibilizer is melted via a glue tank and supplied to the twin-screw via a heated hose. Both the glue tank and the supply hose are heated at a temperature greater than the melting point of the compatibilizer (e.g., 170° C.). The compatibilizers can be added directly to the primary feed hopper.

Two types of regions, conveyance and mixing, are used in the CT-25. In the conveyance region, the materials are heated (including thorough melting in Zone 1 into Zone 2 if needed) and conveyed along the length of the barrel, under low to moderate shear. The mixing section contains special elements that dramatically increase shear and mixing. The length and location of the mixing sections can be changed as needed to increase or decrease shear as needed.

The standard mixing screw for the CT-25 is composed of two mixing sections. The first mixing section is located in zone 3 to 5 and is one RKB 45/5/36 then two RKB45/5/24 followed by two RKB 45/5/12, a reversing RKB 45/5/12 LH (left handed), then 10 RKB 45/5/12 and then a reversing element RSE 24/12 LH followed by conveyance into the second mixing section using five RSE36/36 elements. Prior to the second mixing section is one RSE 24/24 and two RSE 16/16 (right handed conveyance element with 16 mm pitch and 16 mm total element length) elements are used to increase pumping into the second mixing region. The second mixing region, located in zone 7 and zone 8, is one RKB 45/5/36 then two RKB45/5/24 followed by six RKB 45/5/12 and then a full reversing element SE 24/12 LH. The combination of the SE 16/16 elements in front of the mixing zone and single reversing elements greatly increases the shear and mixing. The remaining screw elements are conveyance elements.

An additional screw element type is a reversing element, which can increase the filling level in that part of the screw and provide better mixing. Twin screw compounding is a mature field. One skilled in the art can consult books for proper mixing and dispersion. These types of screw extruders are well understood in the art and a general description can be found in: Twin Screw Extrusion 2E: Technology and Principles, by James White (Hansen Publications). Although specific examples are given for mixing, many different combinations are possible using various element configurations to achieve the needed level of mixing to form the intimate admixtures.

### Example 1

A mixture of 22.5% edible starch with a degree of substitution >0.1 from Shandong Zhucheng Starch PTY, 5% glycerol (>96% purity), 2.7% sorbitol (>70% purity), 11.0% Polycaprolactone PCL Dow Tone 767, 4.5% Attane 4404, and 54.3% Dowlex 2045G is fed to the CT-25 discussed previously at a rate of 20 lb/hr. After producing pellets from the CT-25, these are taken directly to a Collins blown film line with a 30 mm 30 L/D extruder and a 4″ die operating with a 2.5 blow up ratio. The die gap is 2.0 mm and the melt temperature is 180 Celsius. The blown film is 50 microns in thickness.

### Example 2

A mixture of 22.5% edible starch with a degree of substitution >0.1 from Shandong Zhucheng Starch PTY, 5% glycerol (>96% purity), 2.7% sorbitol (>70% purity), 11.0% Epoxidized vegetable oil (Arkema Vikoflex™ 5075), 4.5% Attane 4404, and 54.3% Dowlex 2045G is fed to the CT-25 discussed previously at a rate of 20 lb/hr. After producing pellets from the CT-25, these are taken directly to a Collins blown film line with a 30 mm 30 L/D extruder and a 4″ die operating with a 2.5 blow up ratio. The die gap is 2.0 mm and the melt temperature is 180 Celsius. The blown film is 50 microns in thickness.

### Example 3

A mixture of 22.5% edible starch with a degree of substitution >0.1 from Shandong Zhucheng Starch PTY, 5% glycerol (>96% purity), 2.7% sorbitol (>70% purity), 11.0% Oxidized Polyethylene Wax (HoneyWell AC395), 4.5% Attane 4404, and 54.3% Dowlex 2045G is fed to the CT-25 discussed previously at a rate of 20 lb/hr. After producing pellets from the CT-25, these are taken directly to a Collins blown film line with a 30 mm 30 L/D extruder and a 4″ die operating with a 2.5 blow up ratio. The die gap is 2.0 mm and the melt temperature was 180 Celsius. The blown film is 50 microns in thickness.

### Example 4

A mixture of 22.5% edible starch with a degree of substitution >0.1 from Shandong Zhucheng Starch PTY, 5% glycerol (>96% purity), 2.7% sorbitol (>70% purity), 65.3% of a peroxide “modified Dowlex 2045G”, 4.5% Attane 4404, and 54.3% Dowlex 2045G is fed to the CT-25 discussed previously at a rate of 20 lb/hr. After producing pellets from the CT-25, these are taken directly to a Collins blown film line with a 30 mm 30 L/D extruder and a 4″ die operating with a 2.5 blow up ratio. The die gap is 2.0 mm and the melt temperature is 180 Celsius. The blown film is 50 microns in thickness.

The peroxide modified Dowlex 2045G is prepared as follows: A slurry of 2% dicumyl peroxide and 98% acetone are mixed using a standard lab mixer at room temperature for 10 min. 100 g of this slurry is mixed with 1 kg of Dowlex 2045G pellets and stirred using a lab mixer for 10 min. After stiffing, the wet pellets are uniformly placed on a large backing sheet to fully expose the pellets to open air. The acetone is volatilized overnight at room temperature leaving Dowlex 2045G pellets covered with unreacted dicumyl peroxide. These pellets are termed peroxide modified Dowlex 2045G and are used in the twin screw extrusion process used to produce the film.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A compatibilized thermoplastic polymer-polyolefin composition, said composition having from 5% to 95% bio-based content and comprising:
(a) from 5% to 45%, by weight, thermoplastic starch; and
(b) from 55% to 95%, by weight, modified polyolefin, wherein said modified polyolefin functions as the compatibilizer in the composition.

2. A compatibilized thermoplastic polymer-polyolefin composition, said composition having from 5% to 95% bio-based content and comprising:
(a) from 5% to 45%, by weight, thermoplastic starch;
(b) from 35% to 89%, by weight, polyolefin;
(c) an effective amount of compatibilizer, wherein said compatibilizer is selected from the group consisting of: (1) polar homopolymers and copolymers with inherent polyolefin compatibility; (2) non-polymeric materials with both polar and non-polar functionality; (3) low molecular weight materials with both polar and non-polar functionality; (4) bulk phase/in-situ compatibilizers; and (5) combinations thereof.

3. The composition of claim 2, comprising from 65% to 89%, by weight, polyolefin.

4. The composition of claim 1, having a bio-based content of from 20% to 90%.

5. The composition of claim 2, having a bio-based content of from 20% to 90%.

6. The composition of claim 1, wherein said composition is in the form of a thin flexible film.

7. The composition of claim 2, wherein said composition is in the form of a thin flexible film.

8. The composition of claim 7, wherein the amounts of said thermoplastic starch and compatibilizer, respectively, are present in a ratio of from 5.5:1 to 95:1.

9. The composition of claim 7, wherein said thermoplastic starch comprises a native starch or a modified starch with a plasticizer; wherein said native starch is selected from corn, wheat, potato, rice, tapioca, cassava; wherein said modified starch is a starch ester, starch ether, oxidized starch, hydrolyzed starch, hydroxyalkylated starch; and wherein said plasticizer or mixture of two or more plasticizers is selected from polyhydric alcohols including glycerol, glycerine, ethylene glycol, polyethylene glycol, sorbitol, citric acid and citrate, aminoethanol, or combinations thereof.

10. The composition of claim 9, wherein the thermoplastic starch comprises from 55% to 95% starch and from 5% to 45% plasticizers.

11. The composition of claim 6, wherein said polyolefins include: low-density polyethylene, high-density polyethylene, linear low-density polyethylene, polyolefin elastomers, ethylene copolymers with vinyl acetate, methacrylate, or combinations thereof.

12. The composition of claim 7, wherein said compatibilizer is selected from the group consisting of ethylene vinyl acetate copolymer (EVA), ethylene vinyl alcohol copolymer (EVOH), ethylene acrylic acid (EAA), a graft copolymer of polyethylene and maleic anhydride, and combinations thereof.

13. The composition of claim 7, wherein the amounts of said thermoplastic starch and compatibilizer, respectively, are present in a ratio of from 7.5:1 to 55:1.

14. The composition of claim 7, wherein the amounts of said thermoplastic starch and compatibilizer, respectively, are present in a ratio of from 10:1 to 50:1.

15. The composition of claim 7, comprising from 9% to 20% of a compatibilizer.

16. The composition of claim 7, comprising from 9% to 14% of a compatibilizer.

17. The composition of claim 7, wherein said film has a thickness of from 10 micrometers to 100 micrometers.

18. The composition of claim 7, wherein said film has a thickness of from 15 micrometers to 35 micrometers.

19. A packaging assembly for a consumer product, wherein at least a portion of said packaging assembly comprises the composition of claim 6.

20. A packaging assembly for a consumer product, wherein at least a portion of said packaging assembly comprises the composition of claim 7.

21. A consumer product, wherein at least a portion of said consumer product comprises the composition of claim 6.

22. A consumer product, wherein at least a portion of said consumer product comprises the composition of claim 7.

23. The consumer product of claim 21, wherein said consumer product is an absorbent article selected from the group consisting of diapers, pantiliners, feminine pads, adult incontinence products, wipers, and tissues.

24. The consumer product of claim 22, wherein said consumer product is an absorbent article selected from the group consisting of diapers, pantiliners, feminine pads, adult incontinence products, wipers, and tissues.
